(19) United States
(12) Patent Application Publication
(10) Pub. No.: US 2024/0032181 A1
(43) Pub. Date: Jan. 25, 2024

(54) GENERATING INDUCTIVELY COUPLED PLASMA

(71) Applicant: PERKINELMER U.S. LLC, Shelton, CT (US)

(72) Inventor: Peter Morrisroe, New Milford, CT (US)

(21) Appl. No.: 17/869,985

(22) Filed: Jul. 21, 2022

(51) Int. Cl. H05H 1/42; H05H 1/30

(52) U.S. Cl. CPC H05H 1/42; H05H 1/30; H05H 2242/24; G01N 21/73

(57) ABSTRACT

An inductively coupled plasma (ICP) generator includes a torch, an induction device, and an ignition system. The induction device is configured to be supplied with radio-frequency electric current to inductively energize a plasma gas flowed through the torch to produce a plasma. The ignition system includes a high voltage source. The ignition system is configured to: direct a flow of an ignition gas onto the torch; and generate an ignition electric arc in the ignition gas flow using the high voltage source; whereby the ignition electric arc is transmitted to the torch through the ignition gas flow to ionize the plasma gas in the torch.

### FIELD

The present technology relates to plasma sources and, more particularly, to inductively coupled plasma generators.

### BACKGROUND

An inductively coupled plasma (ICP) torch system is a type of plasma source in which energy is supplied by electric currents that are produced by electromagnetic induction. ICP torch systems are used in some analytical instruments to ionize a sample.

Conventional ICP torches commonly include an ignition system that uses a high voltage source with an electrode in direct contact with an ICP torch body. The high voltage source applies a high voltage to the electrode to ionize a plasma gas within the torch to ignite the plasma gas.

### SUMMARY

According to some embodiments, an inductively coupled plasma (ICP) generator includes a torch, an induction device, and an ignition system. The induction device is configured to be supplied with radio-frequency electric current to inductively energize a plasma gas flowed through the torch to produce a plasma. The ignition system includes a high voltage source. The ignition system is configured to: direct a flow of an ignition gas onto the torch; and generate an ignition electric arc in the ignition gas flow using the high voltage source; whereby the ignition electric arc is transmitted to the torch through the ignition gas flow to ionize the plasma gas in the torch.

According to some embodiments, the ignition system is configured to direct the ignition gas flow across a gap onto the torch.

In some embodiments, the gap has a width of at least 0.1 mm.

According to some embodiments, the ignition electric arc is a direct current (DC) electric arc.

In some embodiments, the ignition electric arc is a pulsed DC electric arc.

In some embodiments, the ignition electric arc is a radio frequency (RF) electric arc.

According to some embodiments, the torch includes a plasma tube, the ignition gas flow contacts the plasma tube, and the ignition system is configured to transmit the ignition electric arc to the plasma tube through the ignition gas flow to ionize the plasma gas in the torch.

In some embodiments, there is no hole in the plasma tube through which an ignition electrode extends.

In some embodiments, the ICP generator is configured such that the ignition electric arc is capacitively coupled through the plasma tube to the plasma gas.

According to some embodiments, the ignition system includes an ignition gas passage, and the ICP generator is configured such that the ignition gas flow and the ignition electric arc travel through the ignition gas passage.

In some embodiments, the ignition gas flow exits the ignition gas passage through an exit port that is open to the atmosphere.

In some embodiments, the ignition system includes a conduit, and the ignition gas passage is defined in the conduit.

In some embodiments, the ignition gas flow exits the ignition gas passage through an exit port, the ignition system includes an ignition gas supply fluidly connected to the ignition gas passage, the ignition system includes a flow restriction in the ignition gas passage between the ignition gas supply and the exit port, the flow restriction divides the passage into a first passage section between the ignition gas supply and the flow restriction and a second passage section between the flow restriction and the exit port, and the ignition gas in the first passage section has a greater density than the ignition gas in the second passage section.

In some embodiments, the ICP generator is configured such that the ignition electric arc is not generated in the ignition gas in the first passage section.

In some embodiments, the ignition system includes a high voltage source electrode in the ignition gas passage to initiate the ignition electric arc in the ignition gas flow.

In some embodiments, the ignition gas flow exits the ignition gas passage through an exit port, the ignition system includes an ignition gas supply fluidly connected to the ignition gas passage, and the high voltage source electrode is in the ignition gas passage upstream of the exit port.

According to some embodiments, the ignition gas is an inert gas.

In some embodiments, the ignition gas is selected from the group consisting of Noble gases.

According to some embodiments, the ignition gas through which the ignition electric arc is transmitted is substantially at atmospheric pressure.

According to some embodiments, the high voltage source is configured to apply a voltage in the range of from about 20 kV to 60 kV to the ignition gas flow to generate the ignition electric arc in the ignition gas flow.

According to some embodiments, the high voltage source is configured to apply a pulsed voltage to the ignition gas flow to generate the ignition electric arc in the ignition gas flow.

In some embodiments, the ignition system is configured to pulse a mass flow rate of the ignition gas flow substantially in synchrony with the pulse of the pulsed voltage to applied the ignition gas flow.

According to some embodiments, a method for generating an inductively coupled plasma (ICP) includes: flowing a plasma gas through a torch; directing a flow of an ignition gas onto the torch; generating an ignition electric arc in the ignition gas flow using a high voltage source, whereby the ignition electric arc is transmitted to the torch through the ignition gas flow to ionize the plasma gas in the torch; and supplying a radio-frequency electric current to an induction device to inductively energize the plasma gas flowing through the torch to produce a plasma.

According to some embodiments, an inductively coupled plasma (ICP) generator includes a torch, an induction device, and an ignition system. The torch includes a plasma tube. The plasma tube is configured to receive a flow of a plasma gas. The induction device is configured to be supplied with radio-frequency electric current to inductively energize the plasma gas flowed through the plasma tube to produce a plasma. The ignition system includes a direct current (DC) high voltage source, and an ignition electrode spaced apart from the plasma tube by a gap. The ignition system is configured to generate an ignition DC electric arc across the gap to the plasma tube using the DC high voltage source to thereby ionize the plasma gas in the torch.

According to some embodiments, the gap has a width of at least 0.1 mm.

In some embodiments, the ignition electric arc is a pulsed DC electric arc.

In some embodiments, the ignition system is configured to: direct a flow of an ignition gas onto the torch; and generate the ignition electric arc in the ignition gas flow using the DC high voltage source; whereby the ignition electric arc is transmitted to the torch through the ignition gas flow and across the gap to ionize the plasma gas in the torch.

According to some embodiments, there is no hole in the plasma tube through which an ignition electrode extends.

In some embodiments, the ICP generator is configured such that the ignition electric arc is capacitively coupled through the plasma tube to the plasma gas.

According to some embodiments, a method for generating an inductively coupled plasma (ICP) includes: flowing a plasma gas through a torch; generating an ignition electric arc from an ignition electrode using a direct current (DC) high voltage source, wherein the ignition electrode is spaced apart from the plasma tube by a gap; and supplying a radio-frequency electric current to an induction device to inductively energize the plasma gas flowing through the torch to produce a plasma.

### BRIEF DESCRIPTION OF THE DRAWINGS

The accompanying drawings, which form a part of the specification, illustrate embodiments of the technology.

FIG. 1 is a schematic view of an ICP generator according to some embodiments.

FIG. 2 is an enlarged, fragmentary, cross-sectional view of the ICP generator of FIG. 2 taken along the line 2-2 of FIG. 1.

FIG. 3 is an illustration of a mass spectroscopy system including an ICP generator according to some embodiments.

FIG. 4 is an illustration of an optical emission spectroscopy system including an ICP generator according to some embodiments.

FIG. 5 is an illustration of an atomic absorption spectroscopy system including an ICP generator according to some embodiments.

### DETAILED DESCRIPTION

The inventors have recognized and appreciated that conventional ICP torches are difficult to remove and readily become damaged. These electrodes, which are conventionally in contact with the ICP torch body, often drag and bind on the torch during removal of the torch, making it difficult to remove the torch. Further, if the electrode becomes bent, then it may not make contact with the torch and may need replaced. The inventors have further recognized and appreciated that an ignition technique that does not require direct contact of the electrodes with the torch body would overcome these shortcomings of conventional ICP torches. Accordingly, some embodiments use an ignition gas to form an electric arc, rather than an electrode in direct contact with the torch body, to ignite the plasma gas.

Embodiments of the technology include an ICP generator including a torch and an ignition system. The ignition system includes a high voltage source and is configured to direct a flow of an ignition gas (e.g., argon gas) onto the torch. The ignition gas flow directly contacts the torch and acts as an electrical conductor of an ionized ignition electric arc from the high voltage source through an air gap to the torch. The ignition arc in turn ionizes a plasma gas (e.g., argon gas) flowing within the torch, and thereby “ignites” the plasma gas. As used herein, “ignites the plasma gas” means that the ignition arc directly or indirectly ionizes a portion of the plasma gas, and the free electrons generated by this ionization assist in or contribute to the subsequent (e.g., downstream) initial creation, by induction energy delivered from a radio frequency (RF) induction device (e.g., an RF induction coil), of a plasma from the plasma gas. The ignition system can eliminate the need for an igniter electrode that is in direct contact with a torch body by providing a non-contact ignition arc supported by the ignition gas flow.

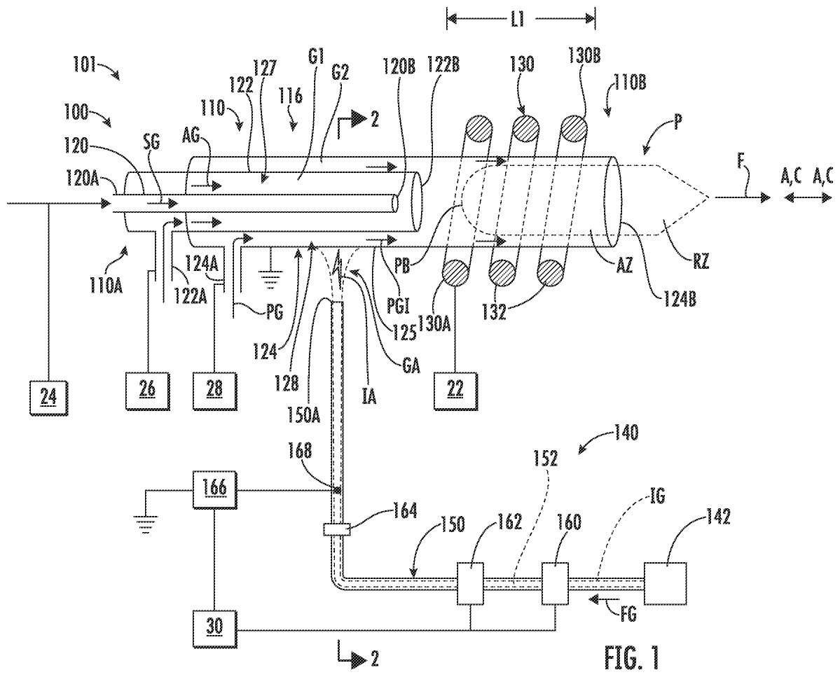

With reference to FIG. 1, an ICP generator system 101 including an ICP generator 100 according to some embodiments is shown therein. The ICP generator system 101 includes the ICP generator 100, a sample source 24, and auxiliary gas source 26, a plasma gas source 28, and a controller 30. The ICP generator 100 includes a flow control subassembly, unit or system 116 (including a torch 110), an RF power generator 22 (electrical power supply), an induction device 130, and an ignition system 140 according to some embodiments.

In use, a sample flow or stream SG (from the sample source 24), an auxiliary gas flow or stream AG (from the auxiliary gas source 26), and a plasma gas flow or stream PG (from the plasma gas source 28) are each forced or flowed through the torch 110 in a forward direction F toward a distal end 110B of the torch 110. The ICP generator 100 generates a plasma P at the distal end 110B from the plasma gas PG and, in some embodiments, from the auxiliary gas AG.

The plasma P may serve as an ionization source. In some embodiments, the plasma P decomposes a sample from the sample stream SG into its constituent elements and transforms those elements into ions. The sample may be an analyte of interest.

The sample source 24 may include a supply of a sample to be analyzed. The sample of interest may be provided in a solution or mixture. The sample source 24 may be any suitable device configured to deliver solid, liquid or gaseous samples to the torch 110. The sample source 24 may include an injector or nebulizer, for example.

The auxiliary gas source 26 may include a supply of the auxiliary gas AG. The auxiliary gas AG may be any suitable gas from which the plasma P can be formed or generated as described herein. In some embodiments, the auxiliary gas AG is argon gas. In other embodiments, the auxiliary gas AG is nitrogen gas. The auxiliary gas source 26 is configured to provide a pressurized supply and flow of the auxiliary gas AG to the torch 110. The auxiliary gas source 26 may include a flow generator (e.g., a pump) and/or may contain a positively pressurized supply of the auxiliary gas AG.

The plasma gas source 28 may include a supply of the plasma gas PG. The plasma gas PG may be any suitable gas for serving the functions as described herein. In some embodiments, the plasma gas PG and the auxiliary gas AG have the same gas composition. In some embodiments, the plasma gas PG is argon gas. In other embodiments, the plasma gas PG is nitrogen gas. The plasma gas source 28 is configured to provide a pressurized supply and flow of the plasma gas PG to the torch 110. The plasma gas source 28 may include a flow generator (e.g., a pump) and/or may contain a positively pressurized supply of the plasma gas PG.

The illustrated flow control system 116 is an example of a suitable torch flow control system for use with the ICP generator system 101; however, it will be appreciated that flow control systems of other designs and constructions may be used in accordance with embodiments of the technology.

The flow control system 116 includes the torch 110 and an injector tube 120. The torch includes an intermediate tube 122 and a plasma tube 124. The intermediate tube 122 circumferentially surrounds the injector tube 120, and the plasma tube 124 circumferentially surrounds the intermediate tube 122. The torch 110 has a torch longitudinal axis A-A, a proximal end 110A and an axially opposing distal, terminal end 110B. The injector tube 120, the intermediate tube 122, and the plasma tube 124 terminate at respective distal, terminal ends proximate the torch terminal end 110B. In some embodiments, the injector tube 120, the intermediate tube 122, and the plasma tube 124 are substantially concentric about the torch axis A-A. In some embodiments, the tubes 120, 122 and 124 form a unitary structure.

In some embodiments, the injector tube 120, the intermediate tube 122, and the plasma tube 124 are each substantially cylindrical and circular in cross-section. The injector tube 120 has an inlet 120A and an outlet 120B. The intermediate tube 122 has an inlet 122A and an outlet 122B. The plasma tube 124 has an inlet 124A and an outlet 124B.

The injector tube 120 defines an axially extending sample passage 126 fluidly connecting the inlet 120A and the outlet 120B. An annular, radial gap G1 is defined between the outer surface of the injector tube 120 and the inner surface of the intermediate tube 122. The gap G1 defines or forms an axially extending, tubular auxiliary gas passage 127 between the opposing surfaces of the injector tube 120 and the intermediate tube 122. The auxiliary gas passage 127 fluidly connects the inlet 122A and the outlet 122B. An annular, radial gap G2 is defined between the outer surface of the intermediate tube 122 and the inner surface of the plasma tube 124. The gap G2 defines or forms an axially extending, tubular plasma gas passage 128 between the opposing surfaces of the intermediate tube 122 and the plasma tube 124. The plasma gas passage 128 fluidly connects the inlet 124A and the outlet 124B.

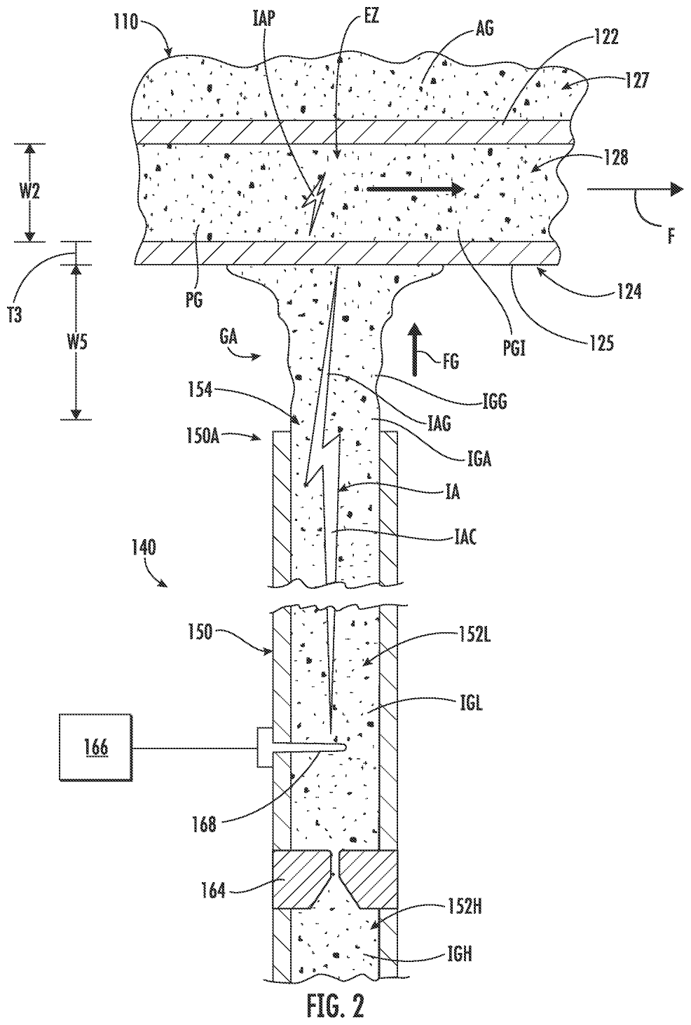

In some embodiments, the nominal width W2 (FIG. 2) of the gap G2 is in the range of from about 0.5 mm to 10 mm, 0.5 mm to 5 mm, 0.5 mm to 1.5 mm, or 0.8 to 1.2 mm.

The sample source 120, the auxiliary gas source 124, and the plasma gas source 124 may be fluidly coupled to the inlet 120A, the inlet 122A, and the inlet 124A, respectively, by corresponding conduits.

The induction device 130 (which may also be referred to an as a load coil or work coil) is electrically connected to the radio-frequency (RF) power supply 22. The RF power supply 22 is configured to provide RF energy or electric current into and through the induction device 130. In some embodiments, the induction coil 130 is a helically wound coil. In some embodiments (e.g., as illustrated in FIG. 1), the induction device 130 is an induction coil. Other types or constructions of induction devices, such as disks (helical or non-helical), can be used. In some embodiments, the induction device 130 is formed of a suitable material, such as copper or aluminum.

In some embodiments, the induction device 130 includes an electrical conductor 130C that is helically wound into a plurality of windings or turns 132 (i.e., the induction device 130 is a helically wound coil). The induction device 130 extends from a proximal end 130A to an opposing distal, terminal end 130B. In some embodiments and as illustrated, the proximal end 130A is defined by the first turn 132 and the distal end 130B is defined by the last turn 132. In some embodiments, the induction device 130 has a coil axis C-C that is substantially coaxial with the torch axis A-A. In some embodiments, the induction device 130 has a length L1 (FIG. 1) in the range of from about 10 mm to 25 mm.

In some embodiments, the injector tube 120 and the intermediate tube 122 are relatively arranged and configured such that the distal terminal end of the intermediate tube 122 extends axially forward of the distal terminal end of the injector tube 120 (e.g., by a distance in the range of from about 0 mm to 5 mm, 0.5 mm to 3 mm, or 1 mm to 2 mm).

The intermediate tube 122 and the plasma tube 124 are relatively arranged and configured such that the distal terminal end of the plasma tube 124 extends axially forward of the distal terminal end of the intermediate tube 124 (e.g., by a distance in the range of from about 25 mm to 50 mm, 30 mm to 45 mm, 35 mm to 40 mm, or 36 mm to 38 mm).

The plasma tube 124 and the induction device 130 are relatively arranged and configured such that the induction device 130 circumferentially surrounds a distal section of the plasma tube 124. That is, the plasma tube 124 extends through the inner passage defined by the induction device 130.

The plasma tube 124 includes a plasma tube wall 125 that forms a torch body or a part of a torch body of the torch 110. In some embodiments, the plasma tube wall 125 is electrically connected to electrical ground. In some embodiments, the plasma tube wall 125 has a thickness T3 (FIG. 2) in the range of from about 0.5 mm to 3 mm, 0.5 mm to 2 mm, or 0.8 mm to 1.2 mm.

In some embodiments and as illustrated in FIG. 1, the outlet opening 124B of the plasma tube 124 is aligned with (i.e., centered on) the torch axis A-A.

The illustrative ignition system 140 includes an ignition gas source 142, a conduit 150, a pressure regulator 160, a control valve 162, a gas restrictor 164, an ignition high voltage source 166, and an electrode 168.

The conduit 150 includes a terminal end 150A, an exit port 154 (FIG. 2) at the terminal end 150A, and an ignition gas passage 152 fluidly coupling the ignition gas source 142 to the exit port 154.

In some embodiments and as illustrated in FIG. 2, the conduit 150 does not contact the plasma tube 124. The conduit terminal end 150A is located proximate but spaced apart from the plasma tube 124 (i.e., the torch body) by a standoff gap, clearance gap, or air gap GA. In some embodiments, the air gap GA has a width W5 (FIG. 2) of at least 0.1 mm. In some embodiments, the air gap width W5 is in the range of from about 0.1 mm to 40 mm. In some embodiments, the air gap width W5 is in the range of from about 1 mm to 2 mm and, in some embodiments, is about 1.5 mm.

The pressure regulator 160, the control valve 162, and the gas restrictor 164, are sequentially interposed along the passage 152 between the ignition gas source 142 to the exit port 154. It will be appreciated that the conduit 150 may include two or more discrete conduits extending between and connecting the components 160, 162, 164. It will also be appreciated that a member (e.g., a manifold) or members of other types including a passage 152 or passages as described herein may be used in place of or in addition to the conduit(s) 150.

The ignition gas source 142 is configured to supply a pressurized flow of an ignition gas IG into the passage 152. The pressure regulator 160 is operable to control or adjust the pressure of the supplied ignition gas IG. The control valve 162 is operable to selectively stop and permit the ignition gas IG to flow through the passage 152 to the exit port 154.

The gas restrictor 164 is operative to restrict the flow of the ignition gas IG through the passage so that the pressure of the ignition gas IG upstream of the gas restrictor 164 (i.e., between the gas restrictor 164 and the valve 162) is substantially greater than the pressure of the ignition gas IG downstream of the gas restrictor 164 (i.e., between the gas restrictor 164 and the exit port 154). The passage 152 thus includes a first or high-pressure passage section 152H extending from the valve 162 to the gas restrictor 164, and a second or low-pressure passage section 152L extending from the gas restrictor 164 to the exit port 154.

The pressure regulator 160 may be any suitable gas pressure regulator device. Suitable pressure regulators may include Type R07 miniature general purpose compressed air regulator available from Norgren, for example.

The control valve 162 may be any suitable gas valve device. Suitable valves may include p/n EH 2012-S72 available from Gems Sensors and Controls, for example.

The gas restrictor 164 may be any suitable gas flow restricting device. In some embodiments, the gas restrictor 164 is a frit. Other gas restrictors may include Brewick CC-1010-006, for example.

The ignition high voltage source 166 is electrically connected to the electrode 168. The electrode 168 is located in the low-pressure passage section 152L so that, in use, the electrode 168 is in contact with the ignition gas flow IG. The ignition high voltage source 166 is operable to apply a high voltage between the electrode 168 and electrical ground. The electrode 168 may be formed of any suitable metal. In some embodiments, the electrode 168 is formed of copper.

The ignition high voltage source 166 may be any suitable high voltage source. As discussed herein, in some embodiments the ignition high voltage source 166 is a DC high voltage source that applies a DC high voltage between the electrode 168 and electrical ground.

The ignition gas IG include a single gas or a mixture of different gases and, as used herein, “ignition gas” refers to the gas mixture in cases where a gas mixture is flowed through the passage 152 as the ignition gas IG.

The ignition gas IG may be any suitable gas (including any suitable mixture of gases). In some embodiments, the ignition gas IG is a gas other than air. In some embodiments, the ignition gas IG is a gas that has a lower electrical breakdown voltage than air at atmospheric pressure (1 atm).

The ignition gas IG may be a substantially pure gas or a gas mixture. In some embodiments, the ignition gas IG is or includes an inert gas and, in some embodiments, a Noble gas. The ignition gas IG should have a voltage dielectric breakdown much lower than the dielectric breakdown of air. In some embodiments, the ignition gas IG is selected from the group consisting of helium, neon, and argon.

The controller 30 typically includes a processor and suitable circuitry to control the various components of the ICP generator system 101. In some embodiments, the controller 30 is configured to control the high voltage source 166 of the ignition system 140. In some embodiments, the controller 30 is configured to also control the valve 162 of the ignition system 140. The controller 30 can also be used to control the pressure regulator 160 of the ignition system 140. The controller 30 can also be used to control the RF generator 22, the sample source 24, the auxiliary gas flow AG from the auxiliary gas source 26, and/or the plasma gas flow PG from the plasma gas source 28.

Embodiments of the controller 30 logic may take the form of an entirely software embodiment or an embodiment combining software and hardware aspects, all generally referred to herein as a “circuit” or “module.” In some embodiments, the circuits include both software and hardware and the software is configured to work with specific hardware with known physical attributes and/or configurations. Furthermore, controller logic may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or other storage devices.

The ICP generator system 101 may be used as follows in accordance with some embodiments. With reference to FIG. 1, the sample gas SG is flowed through the sample gas passage 126, the auxiliary gas AG is flowed through the auxiliary gas passage 127, and the plasma gas PG is flowed through the plasma gas passage 128 in the direction F, each simultaneously. It will be appreciated that the auxiliary gas stream AG is segregated from the sample gas stream SG by the injector tube 120 until the injector tube outlet 122B, and is segregated from the plasma gas stream PG by the intermediate tube 122 until the outlet 122B.

The induction device 130 and the ignition system 140 are used to initiate and sustain the creation of the plasma P. As described in more detail below, the ignition system 140 is operated to energize or ionize the plasma gas PG in the plasma gas passage 128, thereby introducing free electrons into the plasma gas stream PG to form an ionized plasma gas PGI (FIGS. 1 and 2).

The free electrons in the ionized plasma gas stream PGI are then accelerated by an RF field generated by the induction device 130 (which is powered by the power supply 22) in a coil induction region within the induction device 150. This acceleration of the free electrons causes collisions in, and ignition or ionization of, the ionized plasma gas stream PGI. The plasma gas PG is thereby energized into a plasma P. The plasma P may generally include a plasma base PB, an analytical zone AZ, and a plasma tail or recombination zone RZ. The sample gas stream SG may enter the plasma P, where the sample gas stream evaporates and the molecules of the sample of interest break apart and the constituent atoms ionize (e.g., in the analytical zone AZ). In some embodiments, the auxiliary gas AG is also energized by the induction device 150 to form the plasma P therefrom.

Operations of the ignition system 140 will now be described in more detail. The valve 162 is opened to permit the ignition gas IG to flow from the ignition gas source 142, through the ignition gas passage 152, through the exit port 154, across the air gap GA, and to the plasma tube wall 125 (i.e., the torch body). The ignition gas flow IG travels in an ignition gas flow direction FG. The ignition gas flow IG includes a high-pressure portion IGH (high-pressure passage section 152H), a low-pressure portion IGL (in the low-pressure passage section 152L), an atmospheric pressure portion IGA (at the exit port 154), and a gap flow portion IGG (from the exit port 154 to the plasma tube wall 125). The gap flow portion IGG contacts the plasma tube wall 125. The electrode 168 is in contact with the low-pressure portion IGL.

The gas restrictor 164 restricts the flow of the ignition gas IG through the passage, thereby reducing the pressure of the ignition gas IG downstream of the gas restrictor 164. As a result, the pressure of the ignition gas IGH in the high-pressure passage section 152H is substantially greater than the pressure of the ignition gas IGL in the low-pressure passage section 152L (FIG. 2). Because the exit port 154 is open to the atmosphere (i.e., at atmospheric pressure), the ignition gas IGL may be substantially at atmospheric pressure.

Simultaneous with the flowing of the ignition gas IG, the high voltage source 166 applies a high voltage to the electrode 168, and thereby to the low-pressure gas portion IGL. In some embodiments, the electrode 168 is in direct contact with the low-pressure gas portion IGL. The applied voltage exceeds the breakdown voltage of the ignition gas IG, and thereby ionizes the ignition gas IG in the low-pressure passage section 152L. The applied voltage is sufficient to directly ionize the ignition gas IG and to thereby generate an electric arc IA in the ignition gas IG. The electric arc IA travels or propagates, in the ignition gas IG, through the passage 152 from the electrode 168 to the plasma tube wall 125. With reference to FIG. 2, the electric arc IA includes a first arc portion IAC in the passage 152 (extending from the electrode 168 to the exit port 154) and a second arc portion IAG extending across the gap GA (i.e., extending from the exit port 154 to the plasma tube wall 125). The ignition gas IG acts or operates as a fluid conductor of the ionized arc IA from the electrode 168 to the plasma tube wall 125.

In some embodiments and as illustrated, the electric arc IA does not extend into or propagate through the ignition gas IGH in the high-pressure passage section 152H. In some embodiments, this is because the relatively higher pressure of the ignition gas IG in the high-pressure passage section 152H causes the ignition gas IG there to have an electrical breakdown voltage exceeding the applied voltage and exceeding the electrical breakdown voltage of the relatively lower pressure ignition gas IG in the low-pressure passage section 152L. The gas restrictor 164 may serve as a barrier to prevent the arc IA from traveling into the upsteam high-pressure passage section 152H. In some embodiments, no electric arc extends into or propagates through the ignition gas IGH in the high-pressure passage section 152H while the electric arc IA is generated.

The second arc portion IAG extending across the air gap GA contacts the plasma tube wall 125. The arc portion IAG electrically capacitively couples to the plasma gas PG through the plasma tube wall 125 in an energizing zone EZ of the plasma gas passage 128. The energy (represented as a current or spark IAP in FIG. 2) from the arc IA thereby transmitted to the plasma gas PG ionizes or ignites the plasma gas PG to form the ionized plasma gas PGI. The ionized or ignited plasma gas PGI then flows to the induction device 130 where it is converted to the plasma P as described. In accordance with some embodiments, the energy IAP from the electric arc IA ionizes or seeds the flowing plasma gas PG with free electrons upstream of the induction device 130. These free electrons are then energized by the oscillating magnetic field generated by the downstream induction device 130 to thereby ionize the plasma gas PG sufficiently to produce the plasma P.

In some embodiments, the electric arc IA is only generated until the plasma P is generated by the induction device 130. After this time, the plasma P is sustained by the energy from the induction device 130 without the further use of the ignition system 140. In some embodiments, the electric arc IA is only generated for a time period in the range of from about 0.1 second to 30 seconds and, in some embodiments, in the range of 0.5 to 15 seconds, 1 to 5 seconds, or 2 to 3 seconds.

As discussed above, in some embodiments, the ignition gas IGL in the low-pressure passage section 152L is open to the atmosphere (and may therefore be substantially at atmospheric pressure (1 atm)). In some embodiments, the pressure of the ignition gas IGH in the high-pressure passage section 152H is greater than the pressure of the ignition gas IGL in the low-pressure passage section 152L. In some embodiments, the pressure of the ignition gas IGH in the high-pressure passage section 152H is at least 2 PSIG and, in some embodiments, is in the range of 2 to 100 PSIG, 20 to 80 PSIG, 45 to 75 PSIG, or 60 to 70 PSIG.

In some embodiments, the density of the ignition gas IGH in the high-pressure passage section 152H is greater than the density of the ignition gas IGL in the low-pressure passage section 152L.

In some embodiments, the mass flow rate of the ignition gas IG through the exit port 154 is in the range of from about 0.2 L/min to 20 L/min, 1 to 15 L/min, or 5 to 12 L/min.

As discussed above, in some embodiments the electric arc IA does not extend into or propagate through the ignition gas IGH in the high-pressure passage section 152H because the relatively higher pressure of the ignition gas IG in the high-pressure passage section 152H causes the ignition gas IG there to have an electrical breakdown voltage exceeding the applied voltage and exceeding the electrical breakdown voltage of the relatively lower pressure ignition gas IG in the low-pressure passage section 152L. In some embodiments, the ignition electric arc IA can be any voltage higher than the breakdown voltage of the ignition gas IG (e.g., argon gas, helium gas, argon gas mixture, or helium gas mixture). As the arc forms, the ignition arc loads down the ignition voltage to the level of the atmospheric breakdown voltage of the ignition gas IG. According to Paschen's law, the breakdown voltage increases with pressure above atmosphere. Since the ignition voltage is limited by the breakdown voltage of the atmospheric discharge then any pressure level above atmosphere will prevent the discharge from traveling backward through the higher-pressure conduit before (i.e., upstream of) the restrictor 164.

In some embodiments, the high voltage applied by the high voltage source 166 via the electrode 168 (i.e., between the electrode 168 and ground) to the ignition gas IGL in the low-pressure passage 152L to generate the ignition arc IA is greater than the ionization potential of the ignition gas IGL at standard temperature and pressure (STP). In some embodiments, the high voltage applied by the high voltage source 166 via the electrode 168 to the ignition gas IGL in the low-pressure passage section 152L is at least 20 kV and, in some embodiments, is in the range of from about 20 kV to 60 kV.

In some embodiments, the high voltage applied by the high voltage source 166 is a direct current (DC) voltage. In some embodiments, the high voltage source 166 is a DC high voltage generator or power supply. Suitable DC high voltage sources may include TU DaZ 07000408/01 available from Antoss.

In some embodiments, the high voltage applied by the high voltage source 166 is a pulsed DC voltage. In some embodiments, the controller 30 automatically and programmatically pulses the DC voltage. In some embodiments, the controller 30 automatically and programmatically pulses the supply of the ignition gas IG to the low-pressure passage section 152L in tandem or synchrony with the DC voltage, so that the ignition gas IG is flowing when the DC voltage is on and the ignition gas IG is not flowing when the DC voltage is off. For example, the controller 30 alternatingly turn the DC voltage on and open the valve (over the same period of time) and turn the DC voltage off and close the valve (over the same period of time). This control process may serve reduce the amount of the ignition gas IG used.

In some embodiments, the high voltage applied by the high voltage source 166 is an alternating current (AC) voltage. In some embodiments, high voltage source 166 is an AC high voltage generator or power supply. Suitable AC high voltage sources may include an inverter flyback design.

In some embodiments, the high voltage applied by the high voltage source 166 is a radio frequency (RF) voltage. In some embodiments, high voltage source 166 is an RF high voltage generator, power supply or ignitor. Suitable RF high voltage sources may include Dyimore high voltage inverter generator. In some embodiments, the high voltage source 166 applies a high voltage oscillating at a frequency in a range from about 1 KHz to 1 MHz and, in some embodiments, of about 6 kHz.

In some embodiments (e.g., as illustrated), neither the ignition electrode 168 nor the conduit 150 is in contact with the torch body. In some embodiments (e.g., as illustrated), neither the ignition electrode 168 nor the conduit 150 extends through a hole in the torch body. It will be appreciated that ignition systems according to embodiments of the technology provide a non-contact ignition system or mechanism (i.e., no contact between the igniter and the torch body) and can eliminate the problems associated with direct contact ignition electrodes of the prior art.

In some embodiments, the plasma P has a temperature of at least 4000 degrees Celsius and, in some embodiments, a temperature in the range of from about 5000 to 7000 degrees Celsius.

The injector tube 120 may be formed of suitable material. In some embodiments, the injector tube 120 is formed of quartz, sapphire or platinum.

The auxiliary tube 122 may be formed of suitable material. In some embodiments, the auxiliary tube 122 is formed of quartz.

The plasma tube 124 may be formed of suitable material. In some embodiments, the plasma tube wall 125 is formed of an electrically insulating or dielectric material. In some embodiments, the injector tube 124 is formed of quartz.

In some embodiments, the volumetric flow rate of the plasma gas stream PG is in the range of from about 5 to 20 liters/minute, 8 to 15 liters/minute, 7 to 15 liters/minute, or 8 to liters/minute.

In some embodiments, the volumetric flow rate of the sample stream SG is in the range of from about 0 to 2 liters/minute, 0.2 to 1.0 liters/minute, 0.5 to 0.9 liters/minute, or 0.6 to liters/minute, and in some embodiments is about 0.7 liters/minute.

In some embodiments, the volumetric flow rate of the auxiliary gas stream AG is in the range of from about 0 to 2 liters/minute, 0.1 to 1.0 liters/minute, or 0.1 to 0.3 liters/minute, and in some embodiments is about 0.2 liters/minute.

In some embodiments, the pressure of the ignition gas IGL in the low-pressure passage section 152H is about 1 atm.

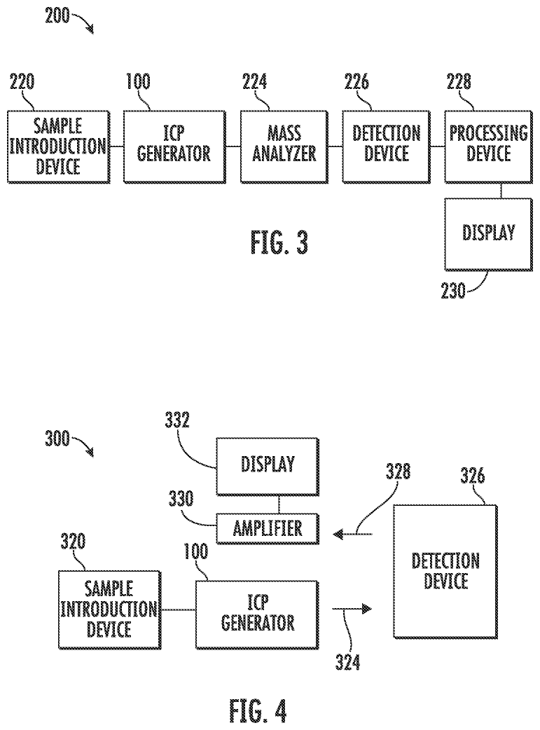

In certain configurations, a torch as described herein can be used in a system configured to perform mass spectrometry (MS). For example and referring to FIG. 3, an ICP-MS device or system 200 includes a sample introduction device 220, an ICP generator 100 as described herein that can be used to sustain an atomization/ionization source, a mass analyzer 224, a detector or detection device 226, a processing device 228 and a display 230.

The sample introduction device 220, ICP generator 100, the mass analyzer 224 and/or the detection device 226 may be operated at reduced pressures using one or more vacuum pumps.

The sample introduction device 220 may include an inlet system configured to provide sample to the torch 110 of the ICP generator 100. The inlet system may include one or more batch inlets, direct probe inlets and/or chromatographic inlets. The sample introduction device 220 may be an injector, a nebulizer or other suitable devices that may deliver solid, liquid or gaseous samples to the torch 110 of the ICP generator 100.

The mass analyzer 224 may take numerous forms depending generally on the sample nature, desired resolution, etc. and exemplary mass analyzers may comprise one or more rod assemblies such as, for example, a quadrupole or other rod assembly.

The detection device 226 may be any suitable detection device that may be used with existing mass spectrometers, e.g., electron multipliers, Faraday cups, coated photographic plates, scintillation detectors, multi-channel plates, etc., and other suitable devices that will be selected by the person of ordinary skill in the art, given the benefit of this disclosure.

The processing device 228 typically includes a microprocessor and/or computer and suitable software for analysis of samples introduced into the MS device 200. One or more databases may be accessed by the processing device 228 for determination of the chemical identity of species introduced into the MS device 200.

In certain configurations, an ICP torch described herein can be used in optical emission spectroscopy (OES). Referring to FIG. 4, an ICP-OES device or system 300 includes a sample introduction device 320, an ICP generator 100 as described herein and optionally comprising one or more induction devices, and a detection device 326.

The sample introduction device 320 may vary depending on the nature of the sample. In certain examples, the sample introduction device 320 may be a nebulizer that is configured to aerosolize liquid sample for introduction into the torch 110 of the ICP generator 100. In other examples, the sample introduction device 320 may be an injector configured to receive sample that may be directly injected or introduced into the torch 110 of the ICP generator 100. Other suitable devices and methods for introducing samples will be readily selected by the person of ordinary skill in the art, given the benefit of this disclosure.

The detector or detection device 326 may take numerous forms and may be any suitable device that may detect optical emissions, such as optical emission 324. For example, the detection device 326 may include suitable optics, such as lenses, mirrors, prisms, windows, band-pass filters, etc. The detection device 326 may also include gratings, such as echelle gratings, to provide a multi-channel OES device. Gratings such as echelle gratings may allow for simultaneous detection of multiple emission wavelengths. The gratings may be positioned within a monochromator or other suitable device for selection of one or more particular wavelengths to monitor. In certain examples, the detection device 326 may include a charge coupled device (CCD). In other examples, the OES device 300 may be configured to implement Fourier transforms to provide simultaneous detection of multiple emission wavelengths.

The detection device 326 may be configured to monitor emission wavelengths over a large wavelength range including, but not limited to, ultraviolet, visible, near and far infrared, etc. The OES device 300 may further include suitable electronics such as a microprocessor and/or computer and suitable circuitry to provide a desired signal and/or for data acquisition. Suitable additional devices and circuitry are known in the art and may be found, for example, on commercially available OES devices such as AVIO 200 series and AVIO 500 series OES devices commercially available from PerkinElmer Health Sciences, Inc. The optional amplifier 330 e.g., a photomultiplier tube, may be operative to increase a signal 328, e.g., amplify the signal from detected photons, and provides the signal to display 332, which may be a readout, computer, etc. In examples where the signal 328 is sufficiently large for display or detection, the amplifier 330 may be omitted. In certain examples, the amplifier 330 is a photomultiplier tube (PMT) configured to receive signals from the detection device 326. Other suitable devices for amplifying signals, however, will be selected by the person of ordinary skill in the art, given the benefit of this disclosure. If desired the PMT can be integrated into the detector 326.

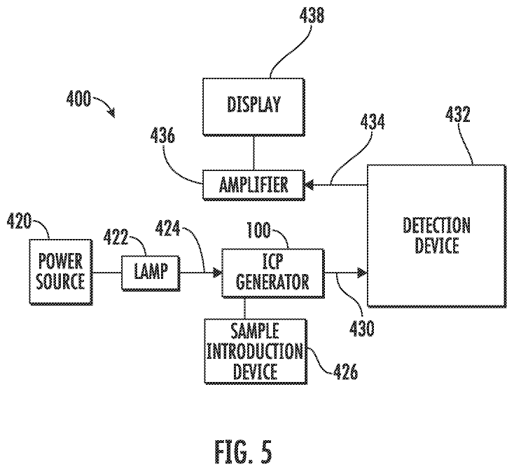

In certain examples, an ICP torch as described herein can be used in an atomic absorption spectrometer (AAS). Referring to FIG. 5, a single beam ICP-AAS 400 comprises a power source 420, a lamp 422, a sample introduction device 426, an ICP generator 100 as described herein, a detector or detection device 432, an optional amplifier 436 and a display 438.

The power source 420 may be configured to supply power to the lamp 422, which provides one or more wavelengths of light 424 for absorption by atoms and ions. Suitable lamps include, but are not limited to mercury lamps, cathode ray lamps, lasers, etc. The lamp may be pulsed using suitable choppers or pulsed power supplies, or in examples where a laser is implemented, the laser may be pulsed with a selected frequency, e.g. 5, 10, or 20 times/second. The exact configuration of the lamp 422 may vary. For example, the lamp 422 may provide light axially along the torch 110 of the ICP generator 100 or may provide light radially along the torch 110. The example shown in FIG. 5 is configured for axial supply of light from the lamp 422.

As sample is atomized and/or ionized in the torch 110 of the ICP generator 100, the incident light 424 from the lamp 422 may excite atoms. That is, some percentage of the light 424 that is supplied by the lamp 422 may be absorbed by the atoms and ions in the torch 110 of the ICP generator 100. The remaining percentage of the light 430 may be transmitted to the detection device 432. The detection device 432 may provide one or more suitable wavelengths using, for example, prisms, lenses, gratings and other suitable devices such as those discussed above in reference to the OES devices, for example. The signal 434 may be provided to the optional amplifier 1636 for increasing the signal provided to the display 438. To account for the amount of absorption by sample in the torch 110, a blank, such as water, may be introduced prior to sample introduction to provide a 100% transmittance reference value. The amount of light transmitted once sample is introduced into the torch 110 of the ICP generator 100 may be measured, and the amount of light transmitted with sample may be divided by the reference value to obtain the transmittance.

AAS device 400 may further include suitable electronics such as a microprocessor and/or computer and suitable circuitry to provide a desired signal and/or for data acquisition. Suitable additional devices and circuitry may be found, for example, on commercially available AAS devices such as AAS spectrometers commercially available from PerkinElmer Health Sciences, Inc.

Where the torch 110 is configured to sustain an inductively coupled plasma, a radio frequency generator electrically coupled to an induction device may be present. In certain embodiments, a double beam AAS device, instead of a single beam AAS device could instead be used.

While certain shapes have been depicted in the drawings for the tubes of the torches (e.g., tubes 120, 122, 124), these shapes are provided for illustrative purposes. It will be appreciated that other shapes may be employed in some embodiments of the technology.

The present technology has been described herein with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described herein, what is conceptually equivalent, and also what incorporates the essential idea of the invention.

1. An inductively coupled plasma (ICP) generator comprising:
a torch;
an induction device configured to be supplied with radio-frequency electric current to inductively energize a plasma gas flowed through the torch to produce a plasma; and
an ignition system including a high voltage source, wherein the ignition system is configured to:
direct a flow of an ignition gas onto the torch; and
generate an ignition electric arc in the ignition gas flow using the high voltage source;
whereby the ignition electric arc is transmitted to the torch through the ignition gas flow to ionize the plasma gas in the torch.

2. The ICP generator of claim 1 wherein the ignition system is configured to direct the ignition gas flow across a gap onto the torch.

3. (canceled)

4. The ICP generator of claim 1 wherein the ignition electric arc is a direct current (DC) electric arc.

5. (canceled)

6. The ICP generator of claim 4 wherein the ignition electric arc is a radio frequency (RF) electric arc.

7. The ICP generator of claim 1 wherein:
the torch includes a plasma tube;
the ignition gas flow contacts the plasma tube; and
the ignition system is configured to transmit the ignition electric arc to the plasma tube through the ignition gas flow to ionize the plasma gas in the torch.

8. The ICP generator of claim 7 wherein there is no hole in the plasma tube through which an ignition electrode extends.

9. (canceled)

10. The ICP generator of claim 1 wherein:
the ignition system includes an ignition gas passage; and
the ICP generator is configured such that the ignition gas flow and the ignition electric arc travel through the ignition gas passage.

11. (canceled)

12. (canceled)

13. The ICP generator of claim 10 wherein:
the ignition gas flow exits the ignition gas passage through an exit port;
the ignition system includes an ignition gas supply fluidly connected to the ignition gas passage;
the ignition system includes a flow restriction in the ignition gas passage between the ignition gas supply and the exit port;
the flow restriction divides the passage into a first passage section between the ignition gas supply and the flow restriction and a second passage section between the flow restriction and the exit port; and
the ignition gas in the first passage section has a greater density than the ignition gas in the second passage section.

14. (canceled)

15. The ICP generator of claim 10 wherein the ignition system includes a high voltage source electrode in the ignition gas passage to initiate the ignition electric arc in the ignition gas flow.

16. The ICP generator of claim 15 wherein:
the ignition gas flow exits the ignition gas passage through an exit port;
the ignition system includes an ignition gas supply fluidly connected to the ignition gas passage; and
the high voltage source electrode is in the ignition gas passage upstream of the exit port.

17. The ICP generator of claim 1 wherein the ignition gas is an inert gas.

18. (canceled)

19. The ICP generator of claim 1 wherein the ignition gas through which the ignition electric arc is transmitted is substantially at atmospheric pressure.

20. (canceled)

21. The ICP generator of claim 1 wherein the high voltage source is configured to apply a pulsed voltage to the ignition gas flow to generate the ignition electric arc in the ignition gas flow.

22. The ICP generator of claim 21 wherein the ignition system is configured to pulse a mass flow rate of the ignition gas flow substantially in synchrony with the pulse of the pulsed voltage to applied the ignition gas flow.

23. A method for generating an inductively coupled plasma (ICP), the method comprising:
flowing a plasma gas through a torch;
directing a flow of an ignition gas onto the torch;
generating an ignition electric arc in the ignition gas flow using a high voltage source, whereby the ignition electric arc is transmitted to the torch through the ignition gas flow to ionize the plasma gas in the torch; and
supplying a radio-frequency electric current to an induction device to inductively energize the plasma gas flowing through the torch to produce a plasma.

24. An inductively coupled plasma (ICP) generator comprising:
a torch including a plasma tube configured to receive a flow of a plasma gas;
an induction device configured to be supplied with radio-frequency electric current to inductively energize the plasma gas flowed through the plasma tube to produce a plasma; and
an ignition system including:
a direct current (DC) high voltage source; and
an ignition electrode spaced apart from the plasma tube by a gap;
wherein the ignition system is configured to generate an ignition DC electric arc across the gap to the plasma tube using the DC high voltage source to thereby ionize the plasma gas in the torch.

25. The ICP generator of claim 24 wherein the gap has a width of at least 0.1 mm.

26. The ICP generator of claim 24 wherein the ignition electric arc is a pulsed DC electric arc.

27. The ICP generator of claim 24 wherein the ignition system is configured to:
direct a flow of an ignition gas onto the torch; and
generate the ignition electric arc in the ignition gas flow using the DC high voltage source;
whereby the ignition electric arc is transmitted to the torch through the ignition gas flow and across the gap to ionize the plasma gas in the torch.

28. The ICP generator of claim 24 wherein there is no hole in the plasma tube through which an ignition electrode extends.

29. (canceled)

30. (canceled)
